(19) United States
(12) Patent Application Publication
(10) Pub. No.: US 2025/0022387 A1
(43) Pub. Date: Jan. 16, 2025

(54) STICKER COMPRISING MECHANORESPONSIVE MATERIAL

(71) Applicant: BIC Violex Single Member S.A., Anoixi (GR)

(72) Inventor: Ion - Ioannis ANTONAKIS, Anoixi (GR)

(73) Assignee: BIC Violex Single Member S.A., Anoixi (GR)

(21) Appl. No.: 18/752,986

(22) Filed: Jun. 25, 2024

(30) Foreign Application Priority Data
Jul. 11, 2023 (EP) 23184656.9

(51) Int. Cl. G09F 3/02; G09F 3/10

(52) U.S. Cl. CPC G09F 3/02; G09F 3/10; G09F 2003/0257; G09F 2003/028

(57) ABSTRACT

A sticker including an adhesive layer configured to be attached to skin a colorant layer. The colorant layer includes a mechanoresponsive material and a plurality of microcapsules comprising a colorant. The microcapsules are disposed within the mechanoresponsive material and the mechanoresponsive material is configured to release the microcapsules when the sticker is exposed to mechanical stress.

### CROSS-REFERENCE TO RELATED APPLICATIONS

This application claims priority to the European Patent Application No. EP23184656.9, filed Jul. 11, 2023, the entire contents of which is incorporated herein by reference.

### TECHNICAL FIELD

The present disclosure relates to the field of stickers. More specifically, the present disclosure relates to stickers comprising mechanoresponsive materials.

### BACKGROUND

A sticker, or decorative patch, is usually a printed product made of paper or plastic. Currently, a sticker commonly comprises PVC film as a top layer, upon which an image is printed. The sticker further comprises a paper or film liner as bottom layer. An adhesive is commonly applied to the bottom layer, to allow attaching the sticker to a variety of surfaces.

Stickers are used for a variety of purposes. Stickers may be used as advertising media, product identifications or as official identification media, for example country stickers on number plates.

Another use of stickers is body ornamentation. For example, stickers, in particular peel-away stickers, may be attached to skin as a temporary tattoo. The latest developments of stickers configured to be used as temporary tattoos have been primarily focused on durability of the stickers. For example, peel-away stickers which last longer on the skin or may only be removed by the use of alcohol have been developed. However, manufacturers of stickers are still limited to only predefined designs.

The present disclosure relates to improved stickers comprising novel technical features to allow the provision of innovative designs and methods of use.

### SUMMARY

In a first aspect, the present disclosure relates to a sticker comprising an adhesive layer configured to be attached to skin, and a colorant layer. The colorant layer comprises a mechanoresponsive material and a plurality of microcapsules comprising a colorant. The microcapsules are disposed within the mechanoresponsive material and the mechanoresponsive material is configured to release the microcapsules when the sticker is exposed to mechanical stress.

The term “mechanoresponsive material” within this disclosure may i.a. refer to its common meaning in the art. Additionally or alternatively, the term “mechanoresponsive material” may refer to a material comprising molecules that respond to mechanical stress, in particular by a change in the molecule's properties. Additionally or alternatively, the term “mechanoresponsive material” may relate to a material configured to change one or more properties when exposed to mechanical stress. Additionally or alternatively, the term “mechanoresponsive material” may relate to a material configured to change a physical property when exposed to mechanical stress. The “properties” or “physical properties” may be for example the material's electric charge, magnetic field, plasticity, strength, stiffness, tension and/or viscosity.

The term “mechanical stress” within this disclosure may i.a. refer to its common meaning in the art. Additionally or alternatively, the term “mechanical stress” may refer to a magnitude of forces that cause deformation. Additionally or alternatively, the term “mechanical stress” may refer to a magnitude of forces per unit of area. Additionally or alternatively, the term “mechanical stress” may refer to tensile and compressive forces, in particular compressive forces.

The term “microcapsules” within this disclosure may i.a. refer to its common meaning in the art. Additionally or alternatively, the term “microcapsules” may relate to droplets surrounded by a coating. Additionally or alternatively, the term “microcapsules” may relate to a small volume of a fluid enclosed by a solid shell. The microcapsules may have a size between about 0.1 μm to about 1000 μm, more specifically between about 0.5 μm to about 100 μm, and in particular between about 1 μm to about 50 μm.

The term “layer” is well-known in the art and i.a. (inter alia) attributed its common meaning in the art. Additionally or alternatively, the term “layer” may refer to a structure, wherein the structure is greater in a first and second dimension compared to a third dimension, in particular wherein the first dimension and second dimension are at least 3 times greater, more specifically at least 5 times greater and in particular at least 10 times greater than the third dimension. Additionally or alternatively, the term “layer” may refer to a structure wherein the structure has a continuous thickness, in particular wherein the thickness is the third dimension. The term “continuous thickness” may refer to at least 80% of the area defined by the first and second dimension having a variation of thickness in the third dimension of less than 30%, in particular less than 15%, relative to the mean thickness.

In some embodiments, the mechanoresponsive material may comprise a plurality of mechanoresponsive fibers, in particular the microcapsules can be disposed between the plurality of mechanoresponsive fibers.

In some embodiments, the mechanoresponsive material may be opaque.

In some embodiments, the microcapsules may comprise a shell encapsulating the colorant. In some embodiments, the shell may be opaque or transparent.

In some embodiments, the microcapsules may be configured to burst when the sticker is exposed to a mechanical stress of between about 0.01 MPa to about 20 MPa, more specifically between about 0.05 MPa to about 5 MPa and in particular between about 0.1 MPa to about 0.5 MPa.

In some embodiments, the microcapsules may be configured to burst when exposed to mechanical stress, more specifically wherein the microcapsules are configured to burst when the microcapsules are exposed to a mechanical stress between about 0.01 MPa to about 20 MPa, more specifically between about 0.05 MPa to about 5 MPa and in particular between about 0.1 MPa to about 0.5 MPa.

In some embodiments, the plurality of microcapsules may comprise an electric charge at their external surface, in particular a positive electric charge.

In some embodiments, the mechanoresponsive material may be configured to generate an electric charge in response to mechanical stress being exerted on the sticker, in particular on the colorant layer, more specifically mechanoresponsive fibers may be configured to generate an electric charge at their surface in response to the mechanical stress being exerted on the mechanoresponsive fibers, in particular a positive electric charge.

In some embodiments, the mechanoresponsive material may comprise a piezoelectric material, more specifically the mechanoresponsive material may comprise a piezoelectric polymer, and in particular the mechanoresponsive material may comprise a fluorine-containing polymer, more specifically polyvinylidene fluoride or a copolymer thereof, in particular polyvinylidene-trifluoroethylene.

In some embodiments, a first subset of the microcapsules may comprise a first colorant and a second subset of the microcapsules may comprise a second colorant different from the first colorant.

In some embodiments, the sticker may have an areal expansion, wherein the plurality of microcapsules may be disposed in up to 70% of the areal expansion relative to the total areal expansion of the sticker.

In some embodiments, the colorant may be in the form of a liquid, more specifically the colorant may be a liquid and/or the colorant may be dissolved or dispersed in a liquid.

In some embodiments, the sticker may comprise a substrate layer, wherein the colorant may be configured to diffuse into the substrate layer upon mechanical stress being exerted on the sticker.

In some embodiments, the substrate layer may comprise a polymer chosen from polyamide, polyethylene terephthalate, polyester, polyethylene and combinations thereof.

In some embodiments, the adhesive layer may be permeable to the microcapsules and/or the colorant, in particular the adhesive layer may be porous.

In some embodiments, the colorant layer may be permeable to the microcapsules and/or the colorant, in particular the colorant layer may be porous.

In some embodiments, the adhesive layer may comprise a silicone adhesive, a polyurethane adhesive, a hydrogel adhesive, a hydrocolloid adhesive, an acrylic adhesive and/or a dry adhesive.

In some embodiments, the sticker may comprise a porous structure, more specifically a porous layer.

In some embodiments, the porous structure may comprise a porous material, in particular a nanoporous material.

In some embodiments, the porous structure may comprise a polymer, in particular a polymer chosen from polycarbonate, polyethylene terephthalate, polyethylene, PETG, LDPE, Nylon, Polyester, Polyamide, an acrylic polymer and combinations thereof.

In some embodiments, the porous structure may comprise pores, wherein the pores may have a diameter smaller than the diameter of the plurality of microcapsules.

In some embodiments, the sticker may comprise a support layer, more specifically a support layer comprising a polymer and in particular a support layer comprising a polymer chosen from polyamide, polyethylene terephthalate, polyester, polyethylene and combinations thereof.

In some embodiments the adhesive layer may form the bottom layer of the sticker. In some embodiments, the colorant layer may be disposed atop the adhesive layer, wherein atop relates to a position further away from the surface on which the sticker is applied to, e.g. human skin, compared to the adhesive layer.

In some embodiments, the porous structure (when present) may be disposed atop the colorant layer, wherein atop relates to a position further away from the surface on which the sticker is applied to, e.g. human skin, compared to the colorant layer. In some embodiments, the support layer may be disposed between the adhesive layer and the colorant layer, in particular in those embodiments wherein the porous structure is disposed atop the colorant layer.

In some embodiments, the support layer may be disposed atop the colorant layer, wherein atop relates to a position further away from the surface on which the sticker is applied to, e.g. human skin, compared to the colorant layer. In some embodiments, the porous structure may be disposed between the adhesive layer and the colorant layer, in particular in those embodiments wherein the support layer is disposed atop the colorant layer.

In a second aspect, the present disclosure relates to a kit of parts comprising a sticker according to the first aspect, and a stamp.

### BRIEF DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting examples. Common reference numerals on different Figures indicate like or similar features.

FIG. 1A shows a sticker 100 according to the first aspect with no predefined design, prior to exposure to mechanical stress.

FIG. 1B shows a sticker 100 according to the first aspect with no predefined design, after exposure to mechanical stress.

FIG. 2A shows a sticker 200 according to the first aspect with a predefined design, prior to exposure to mechanical stress.

FIG. 2B shows a sticker 200 according to the first aspect with a predefined design, after exposure to mechanical stress.

FIG. 3A shows a sticker 300 according to the first aspect configured to stain the skin 300, prior to exposure to mechanical stress.

FIG. 3B shows a sticker 300 according to the first aspect configured to stain the skin 300, after exposure to mechanical stress.

FIG. 3C shows a stain 330 on skin, after the sticker 300 of FIG. 3B has been removed.

FIG. 4A depicts a sticker 400 comprising a colorant layer 460 and a substrate layer 440 prior to being exposed to mechanical stress.

FIG. 4B depicts a sticker 400 comprising a colorant layer 460 and a substrate layer 440 after being exposed to mechanical stress.

FIG. 5A depicts a sticker 500 comprising a colorant layer 560 and a porous structure 570 prior to being exposed to mechanical stress.

FIG. 5B depicts a sticker 500 comprising a colorant layer 560 and a porous structure 570 after being exposed to mechanical stress.

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

In a first aspect, the present disclosure relates to a sticker comprising an adhesive layer configured to be attached to the skin, and a colorant layer. The colorant layer comprises a mechanoresponsive material and a plurality of microcapsules comprising a colorant. The microcapsules are disposed within the mechanoresponsive material and the mechanoresponsive material is configured to release the microcapsules when the sticker is exposed to mechanical stress.

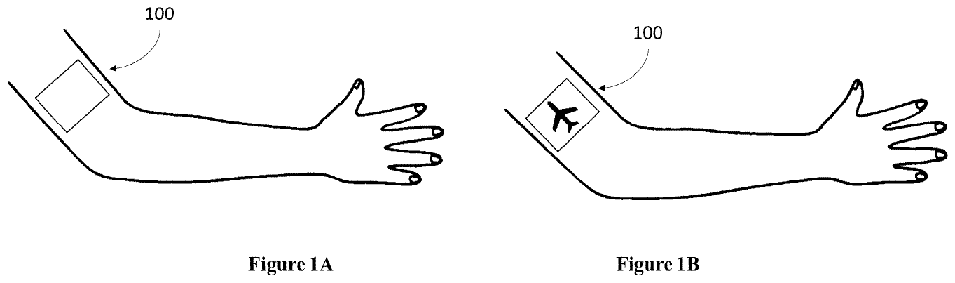

The sticker according to the first aspect may be used in multiple ways. FIG. 1A shows a sticker 100 according to an embodiment according to the first aspect. FIG. 1A shows the sticker 100 in a first state, wherein the microcapsules are disposed within the mechanoresponsive material. The microcapsules of FIG. 1A are not visible, while disposed within the mechanoresponsive material. In some embodiments, the mechanoresponsive material may be opaque. In case the mechanoresponsive material is opaque, the microcapsules disposed therein may not be visible.

When the sticker 100 and thereby the mechanoresponsive material is exposed to mechanical stress, the mechanoresponsive material may release the microcapsules. As a result, as shown in FIG. 1B, the microcapsules may become visible and may form a design. The shape of the resulting design may be determined by where the mechanical stress is applied on the sticker. In some embodiments, the user may apply mechanical stress on the sticker 100 with a finger, guiding the finger along the sticker 100 where he wants to achieve a coloration. Alternatively or additionally, the user may use a stamp with a predefined pattern to apply a design to the sticker 100.

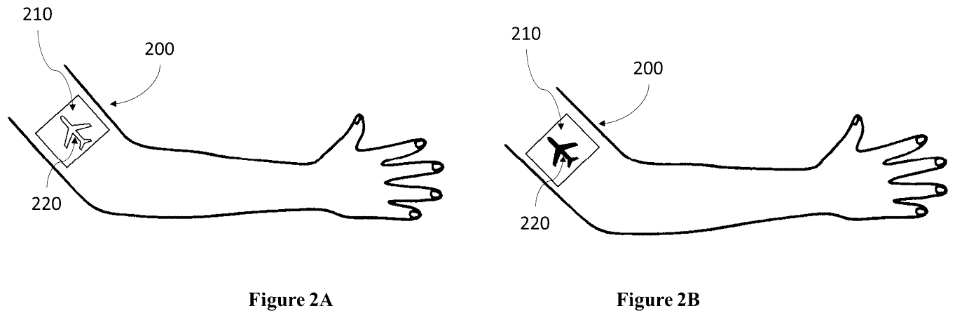

Alternatively, the design of the resulting shape may be predetermined as shown in FIG. 2A. In general, stickers are flat objects with a thickness significantly smaller compared to an areal expansion in the other two dimensions. In other words, the sticker may have an x-axis, y-axis and z-axis, wherein the x-axis and the y-axis define or span a plane, the areal expansion, and wherein the z-axis defines the thickness of the sticker, and wherein the extent of the sticker in the x-axis and the y-axis is significantly larger compared to the z-axis. In particular, the extent of the sticker in the x-axis and the y-axis may be each at least 3 times, more specifically at least 5 times greater than the stickers extent in the z-axis. The sticker 200 shown in FIG. 2A only comprises the plurality of microcapsules in a first part 220 of its areal expansion, e.g. within the plane design shown, and may not comprise the plurality of microcapsules within a second part 210 of its areal expansion. The user may then apply mechanical stress to all of the sticker 200 to make the design of a plane visible, as shown in FIG. 2B. Predetermining the distribution of the plurality of microcapsules may prevent the user from accidentally coloring parts of the sticker 200 that should not be colored.

In some embodiments, the plurality of microcapsules may be disposed in up to 70% of the areal expansion relative to the total areal expansion of the sticker.

In some embodiments, a first subset of the microcapsules may comprise a first colorant and a second subset of the microcapsules may comprise a second colorant different from the first colorant. The first and second colorants may be disposed in different parts of the sticker. In some embodiments, the first colorant may be disposed in a third part of the sticker's areal expansion and the second colorant may be disposed in a fourth part of the sticker's areal expansion. For example, the sticker may be intended to form the design of a sunflower head. The first colorant may be brown and form the disc florets of the sunflower head and the second colorant may be yellow and form the ray florets of the sunflower head.

In some embodiments, the sticker may comprise a plurality of colorant layers. In some embodiments, the sticker may comprise a first colorant layer comprising the first subset of microcapsules and a second colorant layer comprising the second subset of microcapsules. Furthermore, the first colorant layer may comprise a first mechanoresponsive material and the second colorant layer may comprise a second mechanoresponsive material, wherein the first mechanoresponsive material is configured to release the microcapsules when exposed to a lower mechanical stress compared to the second mechanoresponsive material.

In some embodiments, the colorant may be a dye, a pigment, or mixtures thereof, in particular a dye or pigment selected from the group consisting of azoic dyes, triarylmethane dyes, phthalocyanine derivative dyes, xanthene dyes and mixture thereof. In some embodiments, the colorant may be a pigment.

In some embodiments, a dye usable in the sticker according to the present disclosure may include the following: VARIFAST Black 3806 (C.I. Solvent Black 29), 3807 (trimethyl benzyl ammonium salt of C.I. Solvent Black 29), Spirit Black SB (C.I. Solvent Black 5), SPIRON Black GMH (C.I. Solvent Black 43), Solvent Black 46 (salt forming from of C.I. Basic Violet 3 and Acid Yellow 36), VARIFAST Red 1308 (salt forming form of C.I. Basic Red 1 dye and C.I. Acid Yellow 23 dye), Solvent Red 49, VARIFAST Yellow AUM (salt forming form of C.I. Basic Yellow 2 dye and C.I. Acid Yellow 42 dye), SPIRON Yellow C2 GH (organic acid salt of C.I. Basic Yellow 2), SPIRON Violet CRH (C.I. Solvent Violet 8-1), VARIFAST Violet 1701 (salt forming form of C.I. Basic Violet 1 and C.I. Acid Yellow 42 dye), SPIRON Red CGH (organic acid salt of C.I. Basic Red 1), SPIRON Pink BH (C.I. Solvent Red 82), Nigrosine Base EX (C.I. Solvent Black 7), Oil Blue 613 (C.I. Solvent Blue 5), and Neozapon Blue 808 (C.I. Solvent Blue 70).

In some embodiments, a pigments usable in the sticker according to the present disclosure may include organic, inorganic and processed pigments. Thus, in some embodiments, the pigment may be an inorganic pigment such as a carbon black, ultramarine and titanium dioxide pigment, an organic pigment such as an azo-based pigment, phthalocyanine-based pigment, indigo pigment, thioindigo pigment, thren-based pigment, quinacridone-based pigment, anthraquinone-based pigment, thron-based pigment, diketopyrrolopyrrole-based pigment, dioxazine-based pigment, perylene-based pigment, perinone-based pigment and isoindolinone-based pigment, a metal pigment such as an aluminum powder or aluminum powder whose surface is treated with a colored resin, a metal gloss pigment obtained by forming a metal vapor deposition film such as that of aluminum on a transparent or colored transparent film, a metal pigment having a thickness of about 0.01 to about 0.1 μm obtained by peeling a metal vapor deposition film such as that of aluminum formed on a substrate such as a film, a colloidal particle having a mean particle size of about 5 to about 30 nm selected from gold, silver, platinum and copper, a fluorescent pigment, light-storing pigment, pearl pigment obtained by coating the surface of a core which is a naturally occurring mica, synthetic mica, glass flake, alumina and transparent film with a metal oxide such as titanium oxide, and the like.

In some embodiments, the mechanoresponsive material may comprise a plurality of mechanoresponsive fibers, in particular the microcapsules may be disposed between the plurality of mechanoresponsive fibers. When the sticker and thereby the mechanoresponsive fibers are exposed to mechanical stress, the mechanoresponsive fibers may release the microcapsules.

In some embodiments, the plurality of microcapsules may comprise an electric charge at their external surface, in particular a positive electric charge. In other words, the plurality of microcapsules may be electrically charged at their external surface, in particular the plurality of microcapsules may be positively charged at their external surface.

In some embodiments, the mechanoresponsive material may be configured to generate an electric charge in response to mechanical stress being exerted on the sticker, in particular on the colorant layer. More specifically the mechanoresponsive fibers may be configured to generate an electric charge at their surface in response to the mechanical stress being exerted on the mechanoresponsive fibers, in particular a positive electric charge. When the electric charge at the external surface of the microcapsules is the same as the electric charge generated by the mechanoresponsive material, e.g. both are a positive electric charge, the microcapsules may be released from the mechanoresponsive material. In some embodiments, the microcapsules may comprise a negative electric charge at their external surface and the mechanoresponsive fibers may be configured to generate a negative electric charge at their external surface.

In particular, piezoelectric materials may generate an electric charge when exposed to mechanical stress. While there is a wide array of piezoelectric materials, piezoelectric polymers may be particularly suitable for the stickers according to the first aspect, as they may be lightweight and flexible. Accordingly, in some embodiments, the mechanoresponsive material may comprise a piezoelectric material, more specifically the mechanoresponsive material may comprise a piezoelectric polymer, and in particular the mechanoresponsive material may comprise a fluorine-containing polymer, more specifically polyvinylidene fluoride or a copolymer thereof, in particular polyvinylidene-trifluoroethylene.

In a preferred embodiment, the mechanoresponsive material may comprise piezoelectric polymer fibers. In some embodiments, piezoelectric polymer fibers may be produced by electrospinning piezoelectric polymers, in particular polyvinylidene-trifluoroethylene.

In some embodiments, the microcapsules may comprise a shell encapsulating the colorant.

Microencapsulation methods are well-known in the art. In some embodiments, the microencapsulation methods may include conventionally known isocyanate system interfacial polymerization, in situ polymerization such as of melamine-formalin system, submerged coat hardening, phase separation from aqueous solution, phase separation from organic solvent, melt dispersion cooling, air suspension coating and spray drying.

In some embodiments, the shell may be selected from the group of polyamide, polyester, polyurethane, resin urea-formaldehyde, epoxy resin, melamine-formaldehyde, polyethylene, polystyrene, polysiloxane and combinations thereof.

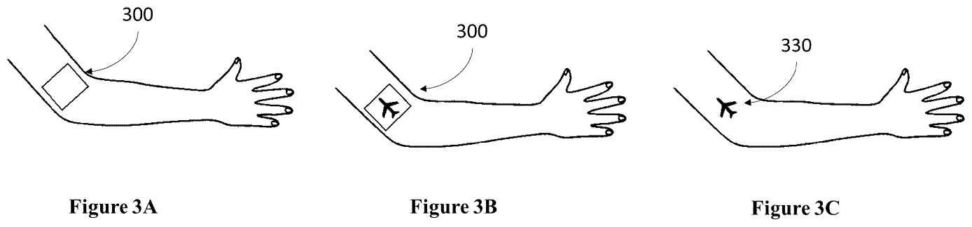

In some embodiments, the sticker may be used as a carrier material from which the microcapsules or the colorant are released. As depicted in FIG. 3A, the sticker 300 may be applied to the skin of the user. Subsequently, mechanical stress may be applied to release the microcapsules from the mechanoresponsive material, as depicted in FIG. 3B. The microcapsules or the colorant therein may then be released from the mechanoresponsive material and subsequently reach the user's skin or another underlying surface and stain it. The underlying surface may be for example a piece of paper or cloth intended to be decorated. Subsequently, the sticker 300 may be removed from the user's skin, while the design remains on the skin as a stain 330, as depicted in FIG. 3C. This action may be performed with a predetermined design, as well as with a design which can be created by the user applying mechanical stress only in particular parts of the sticker 300. It should be noted, that the mechanoresponsive material does not need to be transparent for this embodiment. In some embodiments, the colorant layer may be permeable to the microcapsules and/or the colorant, in particular the colorant layer may be porous. In some embodiments, a colorant layer comprising mechanoresponsive fibers, in particular piezoelectric fibers, may be porous. In some embodiments, the adhesive layer may be permeable to the microcapsules and/or the colorant, in particular the adhesive layer may be porous. The colorant layer and/or the adhesive layer being permeable to the microcapsules and/or the colorant may allow for the microcapsules and/or the colorant to reach the skin or another underlying surface. In some embodiments, the adhesive layer may only cover a part of the sticker's areal expansion. In some embodiments, the adhesive layer may only cover the sticker's rim (perimeter) to secure it in place, and the central part of the sticker may not be covered by the adhesive layer to allow the microcapsules and/or colorant to reach the user's skin or another underlying surface when released from the mechanoresponsive material.

In some embodiments, the microcapsules are configured to burst. More specifically, in some embodiments, the microcapsules may be configured to burst when the sticker is exposed to a mechanical stress of between about between about 0.01 MPa to about 20 MPa, more specifically between about 0.05 MPa to about 5 MPa and in particular between about 0.1 MPa to about 0.5 MPa. In some embodiments, the microcapsules may be configured to burst when exposed to mechanical stress, more specifically the microcapsules may be configured to burst when the microcapsules are exposed to a mechanical stress between about 0 between about 0.01 MPa to about 20 MPa, more specifically between about 0.05 MPa to about 5 MPa and in particular between about 0.1 MPa to about 0.5 MPa. The human finger is typically capable of applying a force of approximately 0.4 MPa. Accordingly, in particular, the microcapsules may be configured to burst when the microcapsules are exposed to a mechanical stress between about 0.1 to about MPa to about 0.5 MPa. The microcapsules bursting may disperse the colorant encapsulated therein, which may result in a better distribution and/or visibility of the colorant. The microcapsules, in particular the microcapsules' shell, may also be opaque to hide the colorant prior to the application of mechanical stress, and bursting of the microcapsules may therefore allow for the visibility of the colorant disposed therein. The microcapsules' resistance to bursting may be adjusted based on whether they are intended to be burst with a finger or with a stamp.

As mentioned above, in some embodiments, the shell may be opaque. The term “opaque” is well-known in the art and i.a. attributed its common meaning in the art. Additionally or alternatively, the term “opaque” may refer to a material property, wherein the material is configured to absorb more than 50%/cm, more specifically more than 60%/cm and in particular more than 70%/cm of light with a wavelength between 380 nm to about 750 nm. In some embodiments, the shell may be transparent. The term “transparent” is well-known in the art and i.a. attributed its common meaning in the art. Additionally or alternatively, the term “transparent” may refer to a material property, wherein the material is configured to absorb less than 30%/cm, more specifically less than 25%/cm and in particular less than 20%/cm of light with a wavelength between 380 nm to about 750 nm. The shell being transparent, may be preferable in embodiments wherein the microcapsules are not configured to burst, as otherwise the colorant may not be visible.

In some embodiments, the colorant may be in the form of a liquid, more specifically the colorant may be a liquid and/or the colorant may be dissolved or dispersed in a liquid. The colorant being in the form of a liquid may result in a greater dispersion of the colorant after bursting of the microcapsules, compared to a solid colorant and compared to the microcapsules themselves. Further, the colorant being in the form of a liquid may allow for greater mobility of the colorant after bursting of the microcapsules, compared to a solid colorant and compared to the microcapsules themselves.

In some embodiments, the sticker may comprise a substrate layer, wherein the colorant may be configured to diffuse into the substrate layer upon mechanical stress being exerted on the sticker. The substrate layer may keep the colorant in place after the microcapsules burst. In some embodiments, the substrate layer may exhibit a wicking effect. The term “wicking effect” is well-known and i.a. attributed its common meaning in the art. Additionally or alternatively, the term “wicking effect” may refer to a material's ability to absorb a liquid by capillary action. The wicking effect may pull the colorant, in particular the colorant in liquid form, into the substrate layer after the microcapsules have burst. The substrate layer may be porous, in particular when exhibiting a wicking effect. In some embodiments, the substrate layer may be disposed atop of the colorant layer, wherein atop relates to a position further away from the surface on which the sticker is applied to, e.g. human skin, compared to the colorant layer. The substrate layer disposed atop of the colorant layer may increase the colorants visibility following the bursting of the microcapsules. In some embodiments, the substrate layer may be disposed below the colorant layer, wherein below relates to a position closer to the surface on which the sticker is applied to, e.g. human skin, compared to the colorant layer.

In some embodiments, substrate layer may comprise a polymer chosen from polyamide, polyethylene terephthalate, polyester, polyethylene and combinations thereof.

The microcapsules bursting may also be particularly advantageous in the embodiment shown in FIGS. 3A to 3C. FIG. 3A illustrated the sticker 300 prior to application of mechanical stress, wherein the sticker is applied to skin. FIG. 3B shows the sticker 300 after application of mechanical stress, wherein the design of a plane has been formed. FIG. 3C shows the skin after application of mechanical stress and removal of the sticker 300. The plurality of microcapsules or the colorant disposed therein has stained the skin, such that the sticker 300 can be removed from the skin, while maintaining the design on the skin. After or while the microcapsules are released from the mechanoresponsive material, the microcapsules may burst. As a result, the colorant itself, instead of the microcapsules, may then stain the skin or the underlying surface. The colorant may be able to penetrate into the upper layer of the skin or of the underlying surface, which may result in the design persisting for a longer duration compared to the design being formed of the microcapsules.

As mentioned above, in some embodiments, the colorant layer and/or adhesive layer may be permeable to the microcapsules and/or the colorant, in particular the colorant layer and/or the adhesive layer may be porous. In some embodiments, the sticker may additionally comprise a porous structure, more specifically a porous layer. In some embodiments, the porous structure may comprise a porous material, in particular a nanoporous material. The porous structure may add mechanical stability to the sticker. The porous structure may be in the form of a porous layer. Additionally, a nanoporous material may prevent microcapsules which are released from the mechanoresponsive material but which have not burst, to reach the user's skin or other underlying surface. The porous structure may therefore aid in preventing accidental actuation of the sticker or accidental release of the microcapsules. Accordingly, in some embodiments, the porous structure may comprise pores, wherein the pores may have a diameter smaller than the diameter of the plurality of microcapsules. The porous structure may only be partially porous, hence, only allowing colorant to pass in specific locations, which may also be used to create an image.

In some embodiments, the porous structure may comprise a polymer, in particular a polymer chosen from polycarbonate, polyethylene terephthalate, polyethylene, PETG, LDPE, Nylon, Polyester, Polyamide, an acrylic polymer and combinations thereof.

In some embodiments, the adhesive layer may comprise a silicone adhesive, a polyurethane adhesive, a hydrogel adhesive, a hydrocolloid adhesive, an acrylic adhesive and/or a dry adhesive.

In some embodiments, the sticker may comprise a support layer, more specifically a support layer comprising a polymer and in particular a support layer comprising a polymer chosen from polyamide, polyethylene terephthalate, polyester, polyethylene and combinations thereof. The support layer may aid improving the stickers mechanical properties. In some embodiments, the support layer may increase the stickers tear resistance. Further, the support layer may act as a barrier to prevent the microcapsules and/or the colorant after the microcapsules have burst, to pass-through. The support layer may be non-porous when used as a barrier.

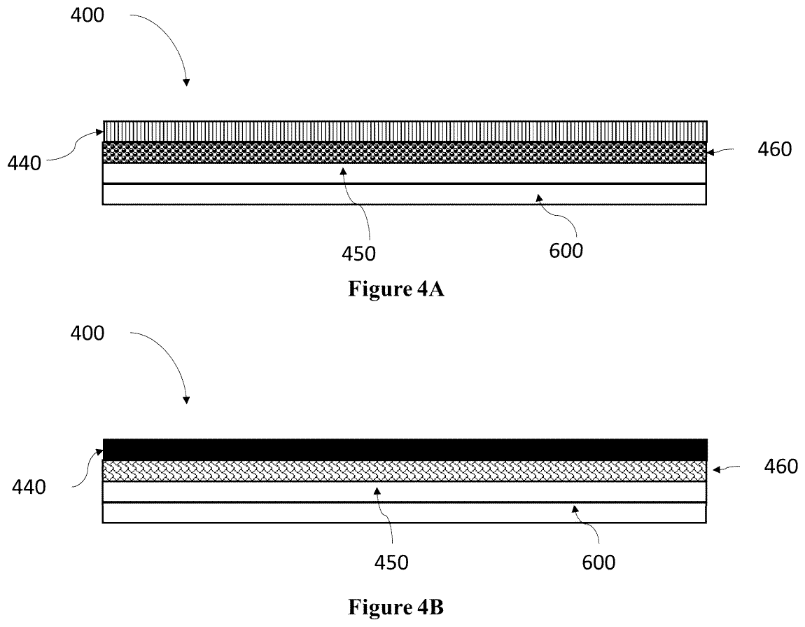

FIG. 4A depicts a sticker 400, prior to being exposed to mechanical stress. The sticker 400 of FIG. 4A comprises a colorant layer 460 comprising the mechanoresponsive material and microcapsules. The mechanoresponsive material may comprise more specifically mechanoresponsive fibers, and in particular piezoelectric fibers. The sticker 400 of FIG. 4A further comprises a substrate layer 440. The sticker 400 further comprises a support layer 450 and is attached to the skin 600.

FIG. 4B depicts the sticker 400 of 4A, after being exposed to mechanical stress. The sticker 400 of FIG. 4A comprises a colorant layer 460 comprising the mechanoresponsive material. However, the microcapsules have burst, hence releasing the colorant. The colorant has diffused into the substrate layer 440. The support layer 450 acted as a barrier, preventing staining the skin 600.

The adhesive layer is not shown in FIG. 4A or FIG. 4B, however, it would be disposed between the other parts of the sticker 400 and the skin 600.

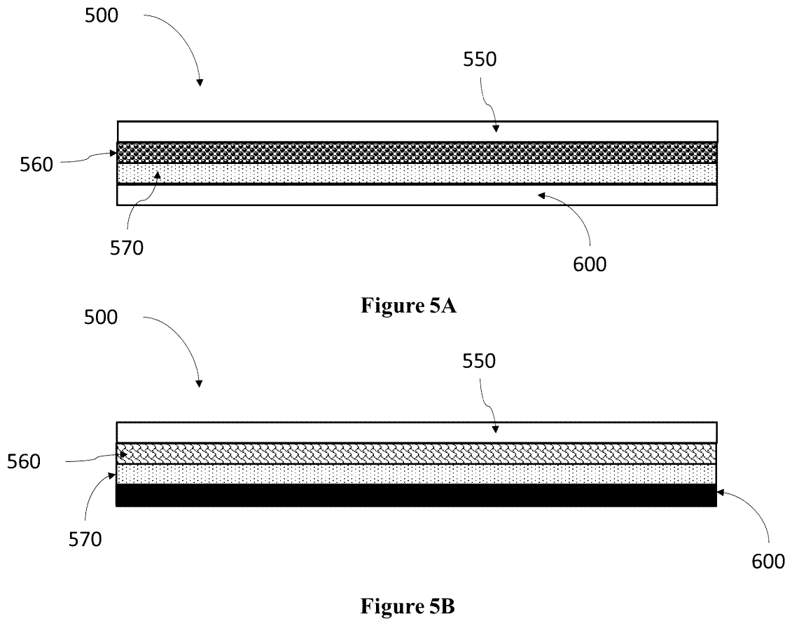

FIG. 5A depicts a sticker 500, prior to being exposed to mechanical stress. The sticker 500 of FIG. 5A comprises a colorant layer 560 comprising the mechanoresponsive material and microcapsules. The mechanoresponsive material may comprise more specifically mechanoresponsive fibers, and in particular piezoelectric fibers. The sticker 500 further comprises a porous structure 570, in particular in the form of a porous layer. The sticker 500 further comprises a support layer 550 and is attached to the skin 600.

FIG. 5B depicts the sticker 500 of 5A, after being exposed to mechanical stress. The sticker 500 of FIG. 5B comprises a colorant layer 560 comprising the mechanoresponsive material. However, the microcapsules have burst, hence releasing the colorant. The colorant has diffused through the porous structure 570 towards the skin 600, resulting in staining of the skin 600. The support layer 550 acted as a barrier, preventing that the colorant exiting from the top of the sticker 500.

The adhesive layer is not shown in FIG. 5A or FIG. 5B, however, it would be disposed between the other parts of the sticker 500 and the skin 600.

In some embodiments, the adhesive layer may form the bottom layer of the sticker. In some embodiments, the colorant layer may be disposed atop the adhesive layer, wherein atop relates to a position further away from the surface on which the sticker is applied to, e.g. human skin, compared to the adhesive layer. The fact that the colorant layer is disposed atop the adhesive layer does not limit the colorant layer to being in direct contact with the colorant layer.

In some embodiments, the porous structure may be disposed atop the colorant layer, wherein atop relates to a position further away from the surface on which the sticker is applied to, e.g. human skin, compared to the colorant layer. In some embodiments, the support layer may be disposed between the adhesive layer and the colorant layer, in particular in those embodiments wherein the porous structure is disposed atop the colorant layer.

In some embodiments, the support layer may be disposed atop the colorant layer, wherein atop relates to a position further away from the surface on which the sticker is applied to, e.g. human skin, compared to the colorant layer. In some embodiments, the porous structure may be disposed between the adhesive layer and the colorant layer, in particular in those embodiments wherein the support layer is disposed atop the colorant layer.

In a second aspect, the present disclosure relates to a kit of parts comprising a sticker according to the first aspect, and a stamp.

Although the present disclosure is defined in the attached claims, it should be understood that the present disclosure can also (alternatively) be defined in accordance with the following aspects:

1. A sticker (100, 200, 300, 400, 500) comprising:
an adhesive layer configured to be attached to skin (600), and
a colorant layer (460, 560) comprising:
a mechanoresponsive material and a plurality of microcapsules comprising a colorant disposed within the mechanoresponsive material,
wherein the mechanoresponsive material is configured to release the microcapsules when the sticker (100, 200, 300, 400, 500) is exposed to mechanical stress.

2. The sticker (100, 200, 300, 400, 500) according to aspect 1, wherein the mechanoresponsive material comprises a plurality of mechanoresponsive fibers, in particular wherein the microcapsules are disposed between the plurality of mechanoresponsive fibers.

3. The sticker (100, 200, 300, 400, 500) according to any preceding aspect, wherein the mechanoresponsive material is opaque.

4. The sticker (100, 200, 300, 400, 500) according to any preceding aspect, wherein the microcapsules comprise a shell encapsulating the colorant, wherein the shell is opaque or transparent.

5. The sticker (100, 200, 300, 400, 500) according to any preceding aspect, wherein the microcapsules are configured to burst when the sticker (100, 200, 300, 400, 500) is exposed to a mechanical stress of between about 0.01 MPa to about 20 MPa, more specifically between about 0.05 MPa to about 5 MPa and in particular between about 0.1 MPa to about 0.5 MPa.

6. The sticker (100, 200, 300, 400, 500) according to any preceding aspect, wherein the microcapsules are configured to burst when exposed to mechanical stress, more specifically wherein the microcapsules are configured to burst when the microcapsules are exposed to a mechanical stress between about 0.01 MPa to about 20 MPa, more specifically between about 0.05 MPa to about 5 MPa and in particular between about 0.1 MPa to about 0.5 MPa.

7. The sticker (100, 200, 300, 400, 500) according to any preceding aspect, wherein the plurality of microcapsules comprise an electric charge at their external surface, in particular a positive electric charge.

8. The sticker (100, 200, 300, 400, 500) according to any preceding aspect, wherein the mechanoresponsive material is configured to generate an electric charge in response to mechanical stress being exerted on the sticker (100, 200, 300, 400, 500), in particular on the colorant layer (460, 560), more specifically wherein mechanoresponsive fibers are configured to generate an electric charge at their surface in response to the mechanical stress being exerted on the mechanoresponsive fibers, in particular a positive electric charge.

9. The sticker (100, 200, 300, 400, 500) according to any preceding aspect, wherein the mechanoresponsive material comprises a piezoelectric material, more specifically wherein the mechanoresponsive material comprises a piezoelectric polymer, and in particular wherein the mechanoresponsive material comprises a fluorine-containing polymer, more specifically polyvinylidene fluoride or a copolymer thereof, in particular polyvinylidene-trifluoroethylene.

10. The sticker (100, 200, 300, 400, 500) according to any preceding aspect, wherein a first subset of the microcapsules comprises a first colorant and a second subset of the microcapsules comprises a second colorant different from the first colorant.

11. The sticker (100, 200, 300, 400, 500) according to any preceding aspect, wherein the sticker (100, 200, 300, 400, 500) has an areal expansion, wherein the plurality of microcapsules are disposed in up to 70% of the areal expansion relative to the total areal expansion of the sticker (100, 200, 300, 400, 500).

12. The sticker (100, 200, 300, 400, 500) according to any preceding aspect, wherein the colorant is in the form of a liquid, more specifically wherein the colorant is a liquid and/or wherein the colorant is dissolved or dispersed in a liquid.

13. The sticker (100, 200, 300, 400, 500) according to any preceding aspect, wherein the sticker (100, 200, 300, 400, 500) comprises a substrate layer (440), wherein the colorant is configured to diffuse into the substrate upon mechanical stress being exerted on the sticker (100, 200, 300, 400, 500).

14. The sticker (100, 200, 300, 400, 500) according to any preceding aspect, wherein the adhesive layer is permeable to the microcapsules and/or the colorant, in particular wherein the adhesive layer is porous.

15. The sticker (100, 200, 300, 400, 500) according to any aspect 13 or 14, wherein the substrate layer (440) comprises a polymer chosen from polyamide, polyethylene terephthalate, polyester, polyethylene and combinations thereof.

16. The sticker (100, 200, 300, 400, 500) according to any preceding aspect, wherein the colorant layer (460, 560) is permeable to the microcapsules and/or the colorant, in particular wherein the colorant layer (460, 560) is porous.

17. The sticker (100, 200, 300, 400, 500) according to any preceding aspect, wherein the adhesive layer comprises a silicone adhesive, a polyurethane adhesive, a hydrogel adhesive, a hydrocolloid adhesive, an acrylic adhesive and/or a dry adhesive.

18. The sticker (100, 200, 300, 400, 500) according to any preceding aspect, wherein the sticker (100, 200, 300, 400, 500) comprises a porous structure (570), more specifically a porous layer.

19. The sticker (100, 200, 300, 400, 500) according to aspect 18, wherein the porous structure (570) comprises a porous material, in particular a nanoporous material.

20. The sticker (100, 200, 300, 400, 500) according to aspect 19, wherein the porous structure comprises a polymer, in particular a polymer chosen from polycarbonate, polyethylene terephthalate, polyethylene, PETG, LDPE, Nylon, Polyester, Polyamide, an acrylic polymer and combinations thereof.

21. The sticker (100, 200, 300, 400, 500) according to any one of aspects 18 to 20, wherein the porous structure comprises pores, wherein the pores have a diameter smaller than the diameter of the plurality of microcapsules.

22. The sticker (100, 200, 300, 400, 500) according to any preceding aspect, wherein the sticker (100, 200, 300, 400, 500) comprises a support layer (450, 550), more specifically a support layer (450, 550) comprising a polymer and in particular a support layer (450, 550) comprising a polymer chosen from polyamide, polyethylene terephthalate, polyester, polyethylene and combinations thereof.

23. A kit of parts comprising:
a sticker (100, 200, 300, 400, 500) according to aspect 1, and
a stamp.

1. A sticker comprising:
an adhesive layer configured to be attached to skin, and
a colorant layer comprising:
a mechanoresponsive material and a plurality of microcapsules comprising a colorant disposed within the mechanoresponsive material,
wherein the mechanoresponsive material is configured to release the microcapsules when the sticker is exposed to mechanical stress.

2. The sticker according to claim 1, wherein the mechanoresponsive material comprises a plurality of mechanoresponsive fibers.

3. The sticker according to claim 1, wherein the mechanoresponsive material is opaque.

4. The sticker according to claim 1, wherein the microcapsules comprise a shell encapsulating the colorant, wherein the shell is opaque or transparent.

5. The sticker according to claim 1, wherein the microcapsules are configured to burst when the sticker is exposed to a mechanical stress of between about 0.1 MPa to about 20 MPa; and/or wherein the microcapsules are configured to burst when exposed to mechanical stress.

6. The sticker according to claim 1, wherein the plurality of microcapsules comprise an electric charge at their external surface.

7. The sticker according to claim 1, wherein the plurality of microcapsules comprise a positive electric charge at their external surface.

8. The sticker according to claim 1, wherein the mechanoresponsive material is configured to generate an electric charge in response to mechanical stress being exerted on the sticker.

9. The sticker according to claim 2, wherein the mechanoresponsive fibers are configured to generate an electric charge at their surface in response to the mechanical stress being exerted on the mechanoresponsive fibers.

10. The sticker according to claim 1, wherein the mechanoresponsive material comprises a piezoelectric material.

11. The sticker according to claim 1, wherein the mechanoresponsive material comprises a piezoelectric polymer.

12. The sticker according to claim 1, wherein the mechanoresponsive material comprises a fluorine-containing polymer.

13. The sticker according to claim 1, wherein the mechanoresponsive material comprises polyvinylidene fluoride or a copolymer thereof, in particular polyvinylidene-trifluoroethylene.

14. The sticker according to claim 1, wherein a first subset of the microcapsules comprises a first colorant and a second subset of the microcapsules comprises a second colorant different from the first colorant.

15. The sticker according to claim 1, wherein the sticker has an areal expansion, wherein the plurality of microcapsules are disposed in up to 70% of the areal expansion relative to the total areal expansion of the sticker.

16. The according to claim 1, wherein the colorant is in the form of a liquid.

17. The sticker according to claim 1, wherein the sticker comprises a substrate layer, wherein the colorant is configured to diffuse into the substrate upon mechanical stress being exerted on the sticker.

18. The sticker according to claim 1, wherein the colorant layer is permeable to the microcapsules and/or the colorant.

19. The sticker according to claim 1, wherein the sticker comprises a porous structure.

20. The sticker according to claim 19, wherein the porous structure comprises pores, wherein the pores have a diameter smaller than the diameter of the plurality of microcapsules.
